(19) United States
(12) Patent Application Publication
(10) Pub. No.: US 2026/0058749 A1
(43) Pub. Date: Feb. 26, 2026

(54) SELECTING MASTER CLOCK USING ARTIFICIAL INTELLIGENCE BASED RECOMMENDATIONS

(71) Applicant: RAKUTEN SYMPHONY, INC., Tokyo (JP)

(72) Inventors: Ramana Reddy MACHIREDDY, Bangalore (IN); Dhruv DUBEY, Bangalore (IN); Jaikishan JAIKUMAR, Bangalore (IN)

(73) Assignee: RAKUTEN SYMPHONY, INC., Tokyo (JP)

(21) Appl. No.: 18/956,692

(22) Filed: Nov. 22, 2024

(30) Foreign Application Priority Data
Aug. 24, 2024 (IN) 202411064018

(51) Int. Cl. H04J 3/06; H04L 41/16

(52) U.S. Cl. CPC H04J 3/0697; H04J 3/0667; H04L 41/16

(57) ABSTRACT

Embodiments of the disclosure describe a method 300 for synchronizing a slave clock with a predicted best master clock. The method 300 includes receiving, at the slave clock, a plurality of PTP announce messages. The method 300 includes determining at least one of a distance and a similarity between each of a plurality of parameters in the received PTP announce message from each master clock and a corresponding plurality of pre-defined reference parameters associated with a reference master clock. The method 300 includes predicting the best master clock among the plurality of master clocks for the clock synchronization. The best master clock is predicted based on the determined at least one of the distance and the similarity between each of the plurality of parameters in the received PTP announce message from each master clock and the corresponding plurality of pre-defined reference parameters associated with the reference master clock.

### CROSS REFERENCE TO RELATED APPLICATION(S)

This application claims priority based on India patent application No. 202411064018 filed Aug. 24, 2024, the entire disclosure of which is incorporated by reference herein.

### FIELD

The present disclosure relates to selecting a master clock using an Artificial Intelligence (AI) based recommendation.

### BACKGROUND

The information disclosed in this background section is only for enhancement of understanding of the general background of the disclosure and should not be taken as an acknowledgement or any form of suggestion that this information forms the prior art already known to a person skilled in the art.

According to Institute of Electrical and Electronics Engineers (IEEE) 1588 specification, a Best Master Clock (BMC) algorithm is employed to select a best master clock among the available one or more potential master clocks for synchronization with a slave clock. This selection process is based on the information carried in one or more Precision Time Protocol (PTP) announce messages sent by the one or more potential master clocks.

For instance, in a 5G network scenario, synchronization among base stations is critical for data integrity and connectivity. A satellite serves as a primary time source, transmitting precise PTP time signals (e.g., PTP announce messages) to base stations (e.g., eNodeBs, gNodeBs, etc.). Upon receiving these PTP time signals, the base stations employ the BMC algorithm, evaluating potential master clocks based on criteria, such as clock quality and stability. If the satellite's clock is deemed superior, it is selected as the master clock. The base stations then synchronize their internal clocks to the satellite's time, ensuring coordinated data transmission and minimal latency. Continuous monitoring of PTP announce messages allows the eNodeB and gNodeB to adaptively switch to the better master clock if detected, thereby maintaining optimal synchronization for high-quality service delivery in the 5G network.

In addition, the PTP announce messages may include a plurality of parameters, such as a PTP Grandmaster (GM) identifier, a GM Priority1, a clock class, a clock accuracy, a GM offset log variance, and a GM Priority2. The PTP GM identifier is a unique identifier for a grandmaster clock, which is a primary reference clock for an entire PTP domain. The GM Priority1 is a first priority value used in the BMC algorithm to determine the best master clock. A lower value indicates a higher priority. The clock class indicates a quality of the clock, with lower values representing higher-quality clocks. The clock accuracy specifies an accuracy of the clock, with lower values indicating higher accuracy. The GM offset log variance represents a stability of the grandmaster clock, with lower values indicating better stability. The GM Priority2 is a second priority value used in the BMC algorithm to determine the best master clock. A lower value indicates a higher priority.

The slave clock evaluates the PTP announce messages received from all the potential master clocks and uses the BMC algorithm to select the best master clock based on the above-mentioned parameters. The algorithm compares the values of these parameters in a specific order, and the clock with the highest priority (lowest numerical values) is chosen as the best master clock, as described in conjunction with FIG. 1.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method is disclosed. The method includes receiving, at a slave clock, a plurality of Precision Time Protocol (PTP) announce messages. Each PTP announce message is associated with a different master clock. Each of the PTP announce messages comprises a plurality of parameters associated with the corresponding master clock. The method further includes determining at least one of a distance and a similarity between each of the plurality of parameters in the received PTP announce message from each master clock and a corresponding plurality of pre-defined reference parameters associated with a reference master clock. The method further includes predicting, using an Artificial intelligence (AI)-Machine Learning (ML) model, a best master clock, among the plurality of master clocks, chosen for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

According to one embodiment of the present disclosure, an apparatus is disclosed. The apparatus is configured to receive, at the slave clock, the plurality of PTP announce messages. Each PTP announce message is associated with a different master clock. Each of the PTP announce messages comprises the plurality of parameters associated with the corresponding master clock. The apparatus is further configured to determine at least one of the distance and the similarity between each of the plurality of parameters in the received PTP announce message from each master clock and the corresponding plurality of pre-defined reference parameters associated with the reference master clock. The apparatus is further configured to predict, using the AI/ML model, the best master clock, among the plurality of master clocks, for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

According to one embodiment of the present disclosure, a non-transitory computer-readable medium storing instructions, the instructions comprising: one or more instructions that, when executed by the apparatus, the apparatus comprising one or more processors, cause the one or more processors is configured to receive, at the slave clock, the plurality of PTP announce messages. Each PTP announce message is associated with a different master clock. Each of the PTP announce messages comprises the plurality of parameters associated with the corresponding master clock. The one or more processors are further configured to determine at least one of the distance and the similarity between each of the plurality of parameters in the received PTP announce message from each master clock and the corresponding plurality of pre-defined reference parameters associated with the reference master clock. The one or more processors are further configured to predict, using the AI/ML model, the best master clock, among the plurality of master clocks, for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates the existing BMCA data set comparison algorithm, according to prior art;

FIG. 2 illustrates a block diagram of an apparatus for predicting a best master clock among a plurality of master clocks, according to an embodiment as disclosed herein;

FIG. 3 is a flow diagram illustrating a method for synchronizing a slave clock with the predicted best master clock, according to an embodiment as disclosed herein; and

FIG. 4 illustrates a diagram of example components of a system, according to an embodiment as disclosed herein.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

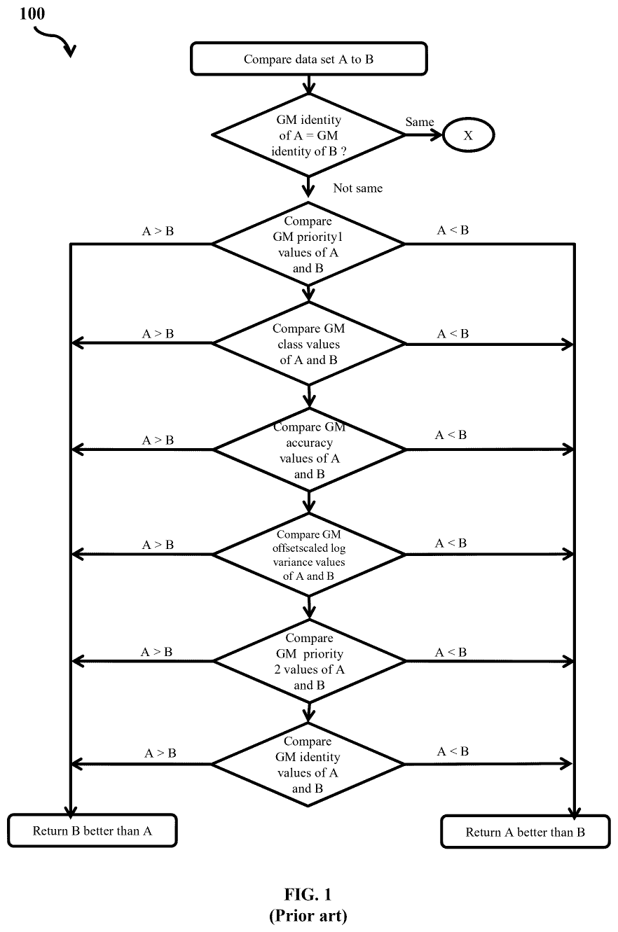

FIG. 1 illustrates an existing BMCA data set comparison algorithm 100, according to prior art. The IEEE 1588 BMC selection procedure involves a systematic evaluation of several key parameters to determine the most suitable master clock (e.g., grand master clock) for synchronization within a Precision Time Protocol (PTP) domain. Consider a scenario for comparing data set A and data set B. The procedure begins by comparing the Grandmaster (GM) Priority 1 values when a GM identity of A and a GM identity of B is equal, the clock with the lower GM Priority 1 value is selected as the preferred master. In cases where the GM Priority 1 values are identical, the next step is to assess the clock class values, with the clock exhibiting the lower Clock Class value being prioritized. If the Clock Class values are also equal, the comparison moves to clock accuracy values, where again, the clock with the lower value is favored. When the clock accuracy values are the same, the GM offset log variance values are examined, and the clock with the lower GM offset log variance is selected. Finally, if all preceding parameters are equal, the GM Priority2 values are compared, with the clock having the lower GM Priority2 value being chosen. This comprehensive selection procedure ensures that the slave clock synchronizes with the most accurate and stable master clock available, thereby optimizing time reference quality across the entire PTP domain.

However, several problems are encountered in the existing IEEE 1588 BMC selection procedure. One significant problem is its reliance on specific PTP timing solution vendors, which often leads to a tightly coupled relationship with the underlying hardware. This platform dependency restricts the implementation of a truly hardware-agnostic software solution, limiting flexibility and scalability across various systems. Additionally, the BMCA algorithm employed in the BMC selection procedure is predominantly based on a series of conditional statements (if-else conditions), which lack the sophistication required for intelligent decision-making. This approach results in a higher Line Of Code (LOC), making the algorithm cumbersome and potentially error-prone.

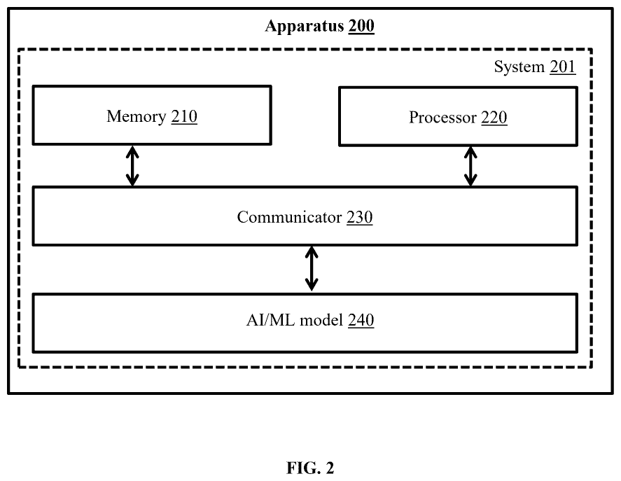

Consequently, there is a need for an alternative solution that enhances the BMC selection procedure by incorporating more advanced methodologies, such as Machine Learning (ML) or adaptive algorithms, to improve decision-making efficiency and ensure compatibility across heterogeneous hardware platforms, as described in conjunction with FIGS. 2 to 4. Such advancements may facilitate a more robust and versatile synchronization mechanism within the PTP domain.

Referring now to the drawings, and more particularly to FIGS. 2 to 4, where similar reference characters denote corresponding features consistently throughout the figures, there are shown preferred embodiments.

FIG. 2 illustrates a block diagram of an apparatus 200 for predicting a best master clock among a plurality of master clocks, according to an embodiment as disclosed herein. Examples of the apparatus 200 may include, but are not limited to, an Evolved NodeB (eNB), a gNodeB (gNB), a base station, a Central Unit (CU), a Distributed Unit (DU), a Network Function (NF), any network entity, etc.

In an embodiment, the apparatus 200 comprises a system 201. The system 201 may include a memory 210, a processor 220, a communicator 230, and an Artificial Intelligence (AI)/Machine Learning (ML) model 240. In one or more embodiments, the system 201 may be implemented on one or multiple electronic devices (not shown in FIG. 2).

In an embodiment, the memory 210 stores instructions to be executed by the processor 220 for predicting the best master clock among the plurality of master clocks, as discussed throughout the disclosure. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit, or it can be an external storage unit of the apparatus 200, a cloud storage, or any other type of external storage.

In an embodiment, the processor 220 communicates with the memory 210, the communicator 230, and the AI/ML model 240. The processor 220 is configured to execute instructions stored in the memory 210 and to perform various processes for predicting the best master clock among the plurality of master clocks, as discussed throughout the disclosure. The processor 220 may include one or a plurality of processors, maybe a general-purpose processor, such as a Central Processing Unit (CPU), an Application Processor (AP), or the like, a graphics-only processing unit such as a Graphics Processing Unit (GPU), a Visual Processing Unit (VPU), and/or an AI dedicated processor such as a Neural Processing Unit (NPU).

In an embodiment, the communicator 230 is configured for communicating internally between internal hardware components and with external devices (e.g., server) via one or more networks (e.g., radio technology). The communicator 230 includes an electronic circuit specific to a standard that enables wired or wireless communication.

In an embodiment, the AI/ML model 240 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the AI/ML model 240 is configured to analyze and interpret vast datasets and/or parameters, enabling the identification of patterns and trends that inform decision-making processes. Initially, the AI/ML model 240 undergoes training using labeled data, allowing it to learn the relationships between input features and desired outputs. Once trained, the AI/ML model 240 can generalize understanding for unseen data, facilitating predictions or classifications. Continuous learning is achieved through iterative updates, refining the model's accuracy over time. The AI/ML model 240 may consist of a plurality of neural network layers and utilize for recommendation systems. Each layer has a plurality of weight values and performs a layer operation through a calculation of a previous layer and an operation of a plurality of weights. Examples of neural networks may include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks.

In one or more embodiments, the AI/ML model 240 may execute multiple operations to predict the best master clock and synchronize a slave clock associated with the apparatus 200 with the predicted best master clock, which are given below.

In one or more embodiments, the AI/ML model 240 is configured to receive, at a slave clock, a plurality of Precision Time Protocol (PTP) announce messages. Each PTP announce message is associated with a different master clock. Each of the PTP announce messages may include a plurality of parameters associated with the corresponding master clock. The plurality of parameters may include, for example, a PTP GM Identifier (Id), a GM first priority (P1), a clock class, a clock accuracy, a GM offset log variance, and a GM second priority (P2).

In one or more embodiments, the AI/ML model 240 is further configured to determine at least one of a distance and a similarity between each of the plurality of parameters in the received PTP announce message from each master clock and a corresponding plurality of pre-defined reference parameters associated with a reference master clock. The plurality of pre-defined reference parameters may include, for example, a PTP GM Identifier (Id), a GM first priority (P1), a clock class, a clock accuracy, a GM offset log variance, and a GM second priority (P2).

In one or more embodiments, the AI/ML model 240 is further configured to predict the best master clock among the plurality of master clocks for clock synchronization. The best master clock is predicted based on the determined at least one of the distance and the similarity between each of the plurality of parameters in the received PTP announce message from each master clock and the corresponding plurality of pre-defined reference parameters associated with the reference master clock. The AI/ML model 240 is further configured to synchronize the slave clock with the predicted best master clock.

In one or more embodiments, the AI/ML model 240 is configured to compute a minimal distance between each of the plurality of parameters in the received PTP announce message and the corresponding plurality of pre-defined reference parameters. The AI/ML model 240 is further configured to select the best master clock among the plurality of master clocks based on the computed minimal distance between each of the plurality of parameters in the received PTP announce message and the corresponding plurality of pre-defined reference parameters.

In one example scenario, the AI/ML model 240 is configured to compute the minimal distance between each parameter in the received PTP announce message and its corresponding plurality of pre-defined reference parameters using the Euclidean distance calculation method. This computation involves determining a square root of a sum of squared differences between the parameter values, providing a quantitative measure of similarity or dissimilarity. Euclidean distance “d” between two points in an n-dimensional space can be expressed as:

$$d = \sqrt{{\sum }_{i = 1}^{n} {( x i - y i )}^{2}} \qquad ( 1 )$$

Here, Xᵢ: Represents the i^{th} parameter value from the received PTP announce message;
Yᵢ: Represents i^{th} corresponding reference parameter value from the pre-defined set of reference parameters; and
n: The total number of parameters being compared.

By assessing these minimal distances, the AI/ML model 240 effectively quantifies how closely each master clock aligns with the reference parameters, which represent ideal characteristics for synchronization. Subsequently, the AI/ML model 240 utilizes these computed distances to evaluate and rank the plurality of master clocks. The selection process identifies the master clock that exhibits the smallest Euclidean distance across one or more relevant parameters, thereby ensuring that the chosen clock is the most compatible and optimal source for synchronization. This approach enhances the precision of the master clock selection process, facilitating improved time accuracy and stability within the PTP domain.

In another example scenario, the AI/ML model 240 is configured to compute the minimal distance between each parameter in the received PTP announce message and its corresponding set of pre-defined reference parameters using a Jaccard distance calculation method. This calculation involves determining a ratio of the intersection to the union of the parameter sets, providing a quantitative measure of similarity or dissimilarity. Jaccard distance “DJ” between two sets A and B can be expressed as:

$${D}_{j} ( A , B ) = 1 - \frac{\vert A ⋂ B \vert}{\vert A ⋃ B \vert} \qquad ( 2 )$$

Here, A: Represents the set of parameters from the received PTP announce message;
B: Represents the set of corresponding pre-defined reference parameters;
   |A∩B|: The size of the intersection of sets A and B, indicating a number of parameters that are common to both sets; and
   |A∪B|: The size of the union of sets A and B, indicating the total number of unique parameters present in either set.

By evaluating these distances, the AI/ML model 240 effectively quantifies the degree to which each master clock aligns with the reference parameters, which represent optimal characteristics for synchronization. Subsequently, the AI/ML model 240 employs these computed Jaccard distances to assess and rank the various master clocks. The selection process identifies the master clock that demonstrates the smallest Jaccard distance across one or more relevant parameters, ensuring that the selected clock is the most compatible and optimal source for synchronization. This methodology enhances the accuracy of the master clock selection process, thereby improving time precision and stability within the PTP domain.

In one or more embodiments, the AI/ML model 240 is configured to compute a closest similarity between each of the plurality of parameters in the received PTP announce message and the corresponding plurality of pre-defined reference parameters. The AI/ML model 240 is further configured to select the best master clock among the plurality of master clocks based on the computed closest similarity between each of the plurality of parameters in the received PTP announce message and the corresponding plurality of pre-defined reference parameters.

In one example scenario, the AI/ML model 240 is configured to compute the closet similarity between two vectors A and B using a cosine similarity “S”, can be expressed as:

$$S ( A , B ) = \frac{A \cdot B}{‖ A ‖ ‖ B ‖} \qquad ( 3 )$$

Here, A: Represents the vector of parameters from the received PTP announce message;
B: Represents the vector of corresponding predefined reference parameters;
A·B: Dot product of vectors A and B; and
∥A∥ and ∥B∥: The magnitudes (or norms) of vectors A and B, respectively.

The AI/ML model 240 computes the cosine similarity for each parameter in the received PTP announce message relative to its corresponding predefined reference parameters. This metric quantifies the cosine of the angle between the two vectors, providing a measure of their directional similarity regardless of magnitude. Subsequently, the AI/ML model 240 utilizes these computed cosine similarities to evaluate and rank the various master clocks. The selection process identifies the master clock that exhibits the highest cosine similarity across one or more relevant parameters, ensuring that the chosen clock is the most compatible and optimal source for synchronization. This methodology enhances the accuracy of the master clock selection process, thereby improving time precision and stability within the PTP domain. In one or more embodiment, the AI/ML model 240 is configured to continuously monitor the time difference between the slave clock and the best master clock to adjust the slave clock accordingly for the clock synchronization

Although FIG. 2 shows various hardware components of the apparatus 200, but it is to be understood that other embodiments are not limited thereon. In other embodiments, the apparatus 200 may include less or more number of components. Further, the labels or names of the components are used only for illustrative purposes and do not limit the scope of the disclosure. One or more components can be combined to perform the same or substantially similar functions to predict the best master clock among the plurality of master clocks.

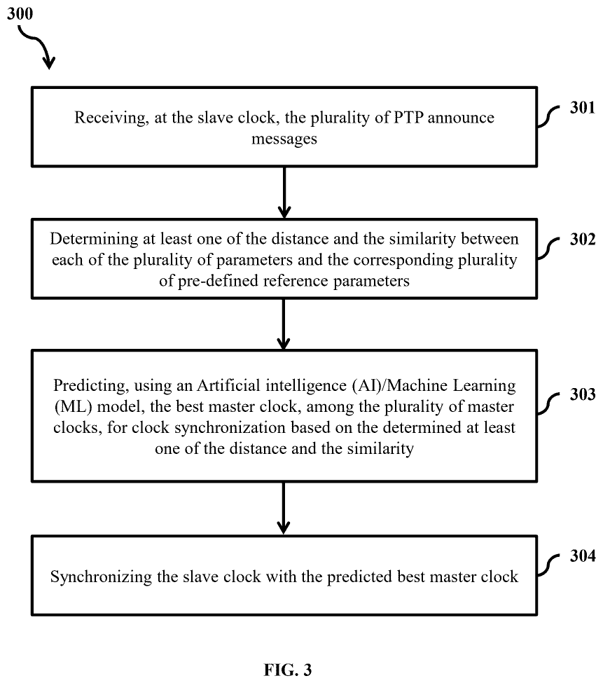

FIG. 3 is a flow diagram illustrating a method 300 for synchronizing the slave clock with the predicted best master clock, according to an embodiment as disclosed herein. The method 300 may execute multiple operations to predict the best master clock and synchronize the slave clock associated with the apparatus 200 with the predicted best master clock, which are given below.

At operation 301, the method 300 includes receiving, at the slave clock, the plurality of PTP announce messages. At operation 302, the method 300 includes determining at least one of the distance and the similarity between each of the plurality of parameters and the corresponding plurality of pre-defined reference parameters. At operation 303, the method 300 includes predicting the best master clock among the plurality of master clocks for the clock synchronization. The best master clock is predicted based on the determined at least one of the distance and the similarity between each of the plurality of parameters and the corresponding plurality of pre-defined reference parameters. At operation 304, the method 300 includes synchronizing the slave clock with the predicted best master clock. Further, a detailed description related to the various operations of FIG. 3 is covered in the description related to FIG. 2 and is omitted herein for the sake of brevity.

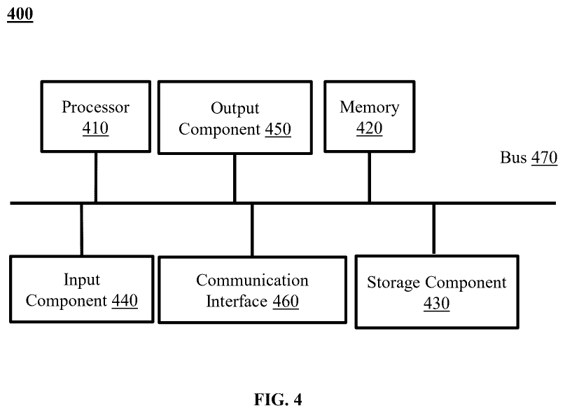

FIG. 4 illustrates a diagram of example components of a system 400, according to an embodiment as disclosed herein. As shown in FIG. 4, the system 400 comprises a processor 410, a memory 420, a storage component 430, an input component 440, an output component 450, a communication interface 460, and a bus 470. In one embodiment, the system 400 may relate to the apparatus 200, or any other network device.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

The memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

The storage component 430 stores information and/or software related to the operation and use of the system 400. For example, the storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

The output component 450 is configured to provide output information from the system 400. For example, the output component 450 may be, but is not limited to, a display, a speaker, instructions to an external device, and/or one or more light-emitting diodes (LEDs).

The communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the system 400 and other devices. In other words, the standard of the communication interface 460 is not limited.

The bus 470 acts as an interconnect between the processor 410, the memory 420, the storage component 430, the input component 440, the output component 450, and the communication interface 460 of the system 400. The bus 470 may include a wired interconnection or a wireless interconnection.

The number and arrangement of components shown in FIG. 4 are provided as an example. In practice, the system 400 may include additional components, fewer components, different components, or differently arranged components than those shown in FIG. 4. Additionally, or alternatively, a set of components (e.g., one or more components) of the system 400 may perform one or more functions described as being performed by another set of components of the system 400. Further, one or more method steps described in any of the embodiments may be performed utilizing the system 400 in communication with one another.

The disclosed method has several advantages over the existing mechanism, for example, which are stated below.
a. Vendor-independent: The disclosed method is not tied to any specific timing solution vendor, effectively decoupling it from hardware dependencies. This enhances flexibility and adaptability across various deployment environments.
b. Platform independence: The disclosed method is inherently platform-independent, making it suitable for integration into Commercial Off-The-Shelf (COTS) telecommunications deployments, particularly within Radio Access Network (RAN) architectures.
c. Advanced methodology: By leveraging state-of-the-art machine learning techniques, the disclosed method addresses the clock synchronization challenges straightforwardly and efficiently, minimizing complexity and reducing a code footprint.
d. Dynamic adaptation: The AI/ML model 240 may dynamically adapt to changes in network conditions or clock performance by continuously analyzing incoming PTP messages, ensuring optimal synchronization even in fluctuating environments. In addition, the AI/ML model 240 may identify complex patterns and relationships that may not be immediately apparent, enhancing the accuracy of the master clock selection.
e. Scalability: The disclosed method may efficiently handle a growing number of master clocks and parameters, making it suitable for large-scale networks where numerous clocks need to be managed.
f. Real-time processing: The AI/ML model 240 may process incoming PTP messages in real-time, allowing for immediate adjustments to synchronization strategies based on the latest data. By accurately predicting the best master clock, the disclosed method may minimize delays associated with clock synchronization, enhancing the performance of time-sensitive applications.

In one or more embodiments, the method includes receiving, at the slave clock, the plurality of PTP announce messages. Each PTP announce message is associated with the different master clock. Each of the PTP announce messages comprises the plurality of parameters associated with the corresponding master clock. The method further includes determining at least one of the distance and the similarity between each of the plurality of parameters in the received PTP announce message from each master clock and the corresponding plurality of pre-defined reference parameters associated with the reference master clock. The method further includes predicting the best master clock among the plurality of master clocks for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

The method described in para [0054], the method further includes synchronizing the slave clock with the predicted best master clock.

The method described in any one of paragraphs [0054]-[0055], the method includes computing the minimal distance between each of the plurality of parameters in the received PTP announce message and the corresponding plurality of pre-defined reference parameters.

The method described in any one of paragraphs [0054]-[0056], the method includes selecting the best master clock among the plurality of master clocks based on the computed minimal distance between each of the plurality of parameters in the received PTP announce message and the corresponding plurality of pre-defined reference parameters.

The method described in any one of paragraphs [0054]-[0057], the method includes computing the closest similarity between each of the plurality of parameters in the received PTP announce message and the corresponding plurality of pre-defined reference parameters.

The method described in any one of paragraphs [0054]-[0058], the method includes selecting the best master clock among the plurality of master clocks based on the computed closest similarity between each of the plurality of parameters in the received PTP announce message and the corresponding plurality of pre-defined reference parameters.

The method described in any one of paragraphs [0054]-[0059], the plurality of parameters in the PTP announce message and the plurality of pre-defined reference parameters comprises at least one of the PTP GM Id, the GM first priority (P1), the clock class, the clock accuracy, the GM offset log variance, and the GM second priority (P2).

The method described in any one of paragraphs [0054]-[0060], the method includes continuously monitoring the time difference between the slave clock and the best master clock to adjust the slave clock accordingly for the clock synchronization.

In one or more embodiments, the apparatus is configured to receive, at the slave clock, the plurality of PTP announce messages. Each PTP announce message is associated with a different master clock. Each of the PTP announce messages comprises the plurality of parameters associated with the corresponding master clock. The apparatus is further configured to determine at least one of the distance and the similarity between each of the plurality of parameters in the received PTP announce message from each master clock and the corresponding plurality of pre-defined reference parameters associated with the reference master clock. The apparatus is further configured to predict, using the AI/ML model, the best master clock, among the plurality of master clocks, for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

In one or more embodiments, the non-transitory computer-readable medium storing instructions, the instructions comprising: one or more instructions that, when executed by the apparatus, the apparatus comprising one or more processors, cause the one or more processors is configured to receive, at the slave clock, the plurality of PTP announce messages. Each PTP announce message is associated with a different master clock. Each of the PTP announce messages comprises the plurality of parameters associated with the corresponding master clock. The one or more processors are further configured to determine at least one of the distance and the similarity between each of the plurality of parameters in the received PTP announce message from each master clock and the corresponding plurality of pre-defined reference parameters associated with the reference master clock. The one or more processors are further configured to predict, using the AI/ML model, the best master clock, among the plurality of master clocks, for clock synchronization. The best master clock is predicted based on the determined at least one of the distance and the similarity between each of the plurality of parameters in the received PTP announce message from each master clock and the corresponding plurality of pre-defined reference parameters associated with the reference master clock.

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device or a combination of hardware devices and software modules.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus (200), wherein the apparatus (200) is configured to:
receive, at a slave clock, a plurality of Precision Time Protocol (PTP) announce messages, wherein each PTP announce message is associated with a different master clock, and wherein each of the PTP announce messages comprises a plurality of parameters associated with the corresponding master clock;
determine at least one of a distance and a similarity between each of the plurality of parameters in the received PTP announce message from each master clock and a corresponding plurality of pre-defined reference parameters associated with a reference master clock;
predict, using an Artificial intelligence (AI)-Machine Learning (ML) model, a best master clock, among the plurality of master clocks, for clock synchronization based on the determined at least one of the distance and the similarity between each of the plurality of parameters in the received PTP announce message from each master clock and the corresponding plurality of pre-defined reference parameters associated with the reference master clock.

2. The apparatus (200) according to claim 1, wherein the apparatus (200) is further configured to:
synchronize the slave clock with the predicted best master clock.

3. The apparatus (200) according to claim 1, wherein to determine the distance, the apparatus (200) is configured to:
compute a minimal distance between each of the plurality of parameters in the received PTP announce message and the corresponding plurality of pre-defined reference parameters.

4. The apparatus (200) according to claim 3, wherein to predict the best master clock among the plurality of master clock, the apparatus (200) is configured to:
select the best master clock among the plurality of master clocks based on the computed minimal distance between each of the plurality of parameters in the received PTP announce message and the corresponding plurality of pre-defined reference parameters.

5. The apparatus (200) according to claim 1, wherein to determine the similarity, the apparatus (200) is configured to:
compute a closest similarity between each of the plurality of parameters in the received PTP announce message and the corresponding plurality of pre-defined reference parameters.

6. The apparatus (200) according to claim 5, wherein to predict the best master clock among the plurality of master clock, the apparatus (200) is configured to:
select the best master clock among the plurality of master clocks based on the computed closest similarity between each of the plurality of parameters in the received PTP announce message and the corresponding plurality of pre-defined reference parameters.

7. The apparatus (200) according to claim 1, wherein the plurality of parameters in the PTP announce message and the plurality of pre-defined reference parameters comprises at least one of a PTP GM Identifier (Id), a GM first priority (P1), a clock class, a clock accuracy, a GM offset log variance, and a GM second priority (P2).

8. The apparatus (200) according to claim 1, wherein the apparatus (200) is configured to:
continuously monitor a time difference between the slave clock and the best master clock to adjust the slave clock accordingly for the clock synchronization.

9. A method (300) comprising:
receiving (301), at a slave clock, a plurality of Precision Time Protocol (PTP) announce messages, wherein each PTP announce message is associated with a different master clock, and wherein each of the PTP announce messages comprises a plurality of parameters associated with the corresponding master clock;
determining (302) at least one of a distance and a similarity between each of the plurality of parameters in the received PTP announce message from each master clock and a corresponding plurality of pre-defined reference parameters associated with a reference master clock; and
predicting (303), using an Artificial intelligence (AI)/Machine Learning (ML) model, a best master clock, among the plurality of master clocks, for clock synchronization based on the determined at least one of the distance and the similarity between each of the plurality of parameters in the received PTP announce message from each master clock and the corresponding plurality of pre-defined reference parameters associated with the reference master clock.

10. The method (300) according to claim 9, further comprising:
synchronizing (304) the slave clock with the predicted best master clock.

11. The method (300) according to claim 9, wherein determining the distance comprises:
computing a minimal distance between each of the plurality of parameters in the received PTP announce message and the corresponding plurality of pre-defined reference parameters.

12. The method (300) according to claim 11, wherein predicting the best master clock among the plurality of master clock comprises:
selecting the best master clock among the plurality of master clocks based on the computed minimal distance between each of the plurality of parameters in the received PTP announce message and the corresponding plurality of pre-defined reference parameters.

13. The method (300) according to claim 9, wherein determining the similarity comprises:
computing a closest similarity between each of the plurality of parameters in the received PTP announce message and the corresponding plurality of pre-defined reference parameters.

14. The method (300) according to claim 13, wherein predicting the best master clock among the plurality of master clock comprises:
selecting the best master clock among the plurality of master clocks based on the computed closest similarity between each of the plurality of parameters in the received PTP announce message and the corresponding plurality of pre-defined reference parameters.

15. The method (300) according to claim 9, wherein the plurality of parameters in the PTP announce message and the plurality of pre-defined reference parameters comprises at least one of a PTP GM Identifier (Id), a GM first priority (P1), a clock class, a clock accuracy, a GM offset log variance, and a GM second priority (P2).

16. The method (300) according to claim 9, comprising:
continuously monitoring a time difference between the slave clock and the best master clock to adjust the slave clock accordingly for the clock synchronization.

17. A non-transitory computer-readable medium storing instructions, the instructions comprising: one or more instructions that, when executed by an apparatus (200), the apparatus (200) comprising one or more processors, cause the one or more processors to:
receive, at a slave clock, a plurality of Precision Time Protocol (PTP) announce messages, wherein each PTP announce message is associated with a different master clock, and wherein each of the PTP announce messages comprises a plurality of parameters associated with the corresponding master clock;
determine at least one of a distance and a similarity between each of the plurality of parameters in the received PTP announce message from each master clock and a corresponding plurality of pre-defined reference parameters associated with a reference master clock;
predict, using an Artificial intelligence (AI)-Machine Learning (ML) model, a best master clock, among the plurality of master clocks, for clock synchronization based on the determined at least one of the distance and the similarity between each of the plurality of parameters in the received PTP announce message from each master clock and the corresponding plurality of pre-defined reference parameters associated with the reference master clock.
